(19) United States
(12) Patent Application Publication
(10) Pub. No.: US 2008/0205429 A1
(43) Pub. Date: Aug. 28, 2008

(54) Channel assignments in carrier sense wireless networks

(76) Inventor: Ping Chung Ng, Oxford (GB)

Correspondence Address: Ping Chung NG;St. Catherine's College, Manor Road, Oxford, OX1 3UJ, omitted

(21) Appl. No.: 11/710,634

(22) Filed: Feb. 26, 2007

(51) Int. Cl. H04L 12/413

(52) U.S. Cl. 370/445

(57) ABSTRACT

In a method for assigning transmission channels to links based on link-directionality in carrier sense wireless networks. The transmissions between two nodes of a link can be split into two channels based on their link-directionalities, one channel for transmitting traffic in one direction while the other channel for sending traffic in another direction. Simultaneous transmissions of a nearby node can be assigned based on link-directionality with a different transmission channel if it is within the carrier sensing region of the link or the same transmission channel if it is far enough from the link, which does not affect the reception of the link.

### BACKGROUND

1. Field of the Invention

The present invention relates to a method fo, assigning transmission channels based on link-directionality in carrier sense wireless networks.

2. Background of the Invention

Substantial effort has been exerted in the past and is continuing to be directed toward network capacity improvements in carrier sense wireless networks (e.g. IEEE 802.11 Wireless LAN, carrier sense wireless sensor and ad-hoc networks, IEEE 802.15.4 Zigbee). One solution is to use multiple channels in wireless networks.

There are a number of multi-channel protocols for carrier sense wireless networks. J. Mo, H. W. So, J. Walrand, “Comparison of Multi-Channel MAC Protocols,” ACM MSWiM'05, October 2005 compared some of them and classified them into three categories: 1) dedicated control channel, 2) common hopping and 3) split phase.

Category 1 used an independent control channel to exchange Request to send (RTS) and Clear to send (CTS) control packets which contain the channel information for channel assignments before transmitting Data and Acknowledgement (ACK) packets in data channels.

Category 2 proposed to split the transmission time into two phases: i) control phase and ii) data phase. During the control phase, all nodes switch to the control channel and allocate the transmission channels for the next data phase.

Category 3 used pre-assigned hopping patterns to switch channels for transmitting RTS/CTS packets until agreements are made between nodes. Then, they will use the concurred channels for data transmissions.

Our method does not belong to these categories. Instead, it assigns channels based on link-directionality. A major advantage of this method is its potential in multiplying the network capacity of densely packed wireless network.

### OBJECT OF THE INVENTION

It is a further object of the invention to provide a method for channel allocations based on link-directionality in carrier sense wireless networks, which may improve network capacities.

### SUMMARY OF THE INVENTION

According to an aspect of the present invention, in a method for assigning transmission channels to links based on link-directionality in carrier sense wireless networks. The transmissions between two nodes of a link can be split into two channels based on their link-directionalities, one channel for transmitting traffic in one direction while the other channel for sending traffic in another direction. Simultaneous transmissions of a nearby node can be assigned based on link-directionality with a different transmission channel if it is within the carrier sensing region of the link or the same transmission channel if it is far enough from the link, which does not affect the reception of the link.

### BRIEF DESCRIPTION OF THE DRAWINGS

FIG. 1 illustrates a closely packed carrier sense wireless network

FIG. 2 illustrates a closely packed carrier sense wireless network with channel assignments based on link-directionality

### DETAILED DESCRIPTION

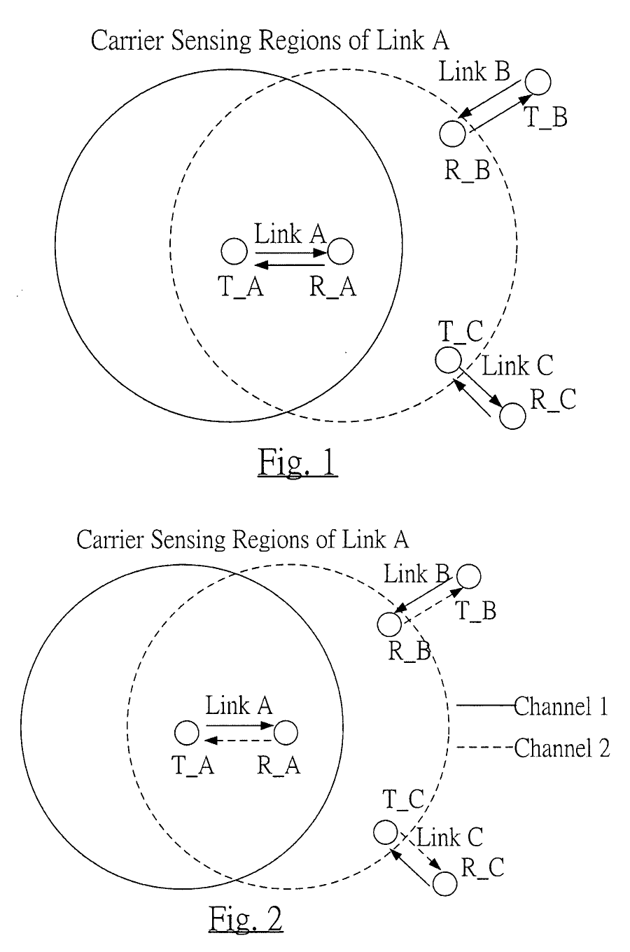

As shown in FIG. 1, the exemplary network is a closely packed network. With a single-channel carrier sense wireless protocol, only one of the links A, B or C can transmit at one time. Since all the links are within the carrier sensing range of each other, simultaneous transmissions of links may cause collisions. For example, when T_A is transmitting data to R_A and T_C is sending data to R_C, collision may occur at R_A because R_A can sense both data signals from T_A and T_C. Therefore, many carrier sense multiple access protocol (CSMA) allows only one transmission at one time within a carrier sensing range. This in turn limits the network capacity.

To overcome the above situation, the present invention splits the transmissions between two nodes of a link into two channels based on their link-directionalities. Let us consider the case where there are two channels, s and t. In FIG. 1, T_A transmits traffic to R_A in one channel (e.g., channel s) while R_A sends traffic to T_A in another channel (e.g., channel t). The channels are assigned dynamically based on the directionality, network topology, and who else are transmitting the neighborhood. Traffic from T_A can be transmitted in either channel s or t, and thus traffic from R_A will be sent in the other channel (t or s). The main idea is to allow the simultaneous transmission of another link i within the carrier sensing regions of T_A and R_A provided that the transmissions of link i do not interfere with the receptions of signals at T_A and R_A. There are two possible cases:

Case 1: the transmissions of link i within the carrier sensing region use a different channel, and thus these do not affect the reception of T_A or R_A in another channel.

Case 2: the transmissions of link i use the same channel as the reception of T_A or R_A but those transmissions are far enough from T_A or R_A.

FIG. 2 shows the same network topology as FIG. 1 with the channel assignments based on the Cases 1 and 2. Assuming T_A uses channel 1 to transmit traffic to R_A and R_A sends traffic to T_A via another independent channel 2. For link C to transmit simultaneously with link A, we can assign channel 1 for the transmission from R_C to T_C. This will not lead to collisions at R_A because the signal from R_C is much weaker than the signal from T_A when they reach R_A (Case 2). T-C can then use channel 2 to transmit traffic to R_C. This, again, will not incur collisions at R_A because T_C is using another independent channel for transmissions (Case 1). Similarly, for link B, T_B can use channel 1 to transmit while R_B can use channel 2 to reply. In this way, links A, B and C can transmit simultaneously which multiplies the network capacity by three times in this exemplary network.

Carrier sense wireless networks can be Wi-Fi (IEEE 802.11), Bluetooth (IEEE 802.15), ZigBee (IEEE 802.15.4) or any kinds of carrier sense wireless networks.

What is claimed is:

1. The method for assigning transmission channels to links based on link-directionality in carrier sense wireless networks.

2. The method of claim 1, wherein the transmissions between two nodes of a link can be split into two channels based on their link-directionalities, one channel for transmitting traffic in one direction while the other channel for sending traffic in another direction.

3. The method of claim 1, wherein the simultaneous transmissions of a nearby node within the carrier sensing region of a link can be assigned with a different transmission channel based on link-directionality which does not affect the reception of the link.

4. The method of claim 1, wherein the simultaneous transmissions of a nearby node can be assigned with the same transmission channel based on link-directionality if the node is far enough from the link which does not affect the reception of the link.

5. The method for assigning transmission channels to links based on link-directionality in carrier sense wireless networks, the method comprising the steps of assigning a different transmission channel based on link-directionality to a nearby node within the carrier sensing region of a link which does not affect the reception of the link, and assigning the same transmission channel based on link-directionality to a nearby node if the node is far enough from the link which does not affect the reception of the link.

6. The method for assigning transmission channels to links based on link-directionality in carrier sense wireless networks, the method comprising the steps of splitting the transmissions between two nodes of a link into two channels based on their link-directionalities, one channel for transmitting traffic in one direction while the other channel for sending traffic in another direction, assigning a different transmission channel based on link-directionality to a nearby node within the carrier sensing region of a link which does not affect the reception of the link, and assigning the same transmission channel based on link-directionality to a nearby node if the node is far enough from the link which does not affect the reception of the link.
